(19) United States
(12) Patent Application Publication
(10) Pub. No.: US 2002/0152392 A1
(43) Pub. Date: Oct. 17, 2002

(54) Method for securely providing encryption keys

(75) Inventors: Douglas A. Hardy, Scottsdale, AZ (US); Sherman W. Paskett, Scottsdale, AZ (US)

Correspondence Address: Stanley A. Schlitter, JENNER & BLOCK, LLC, One IBM Plaza, Chicago, IL, 60611, US

(73) Assignee: Motorola, Inc.

(21) Appl. No.: 09/833,005

(22) Filed: Apr. 12, 2001

(51) Int. Cl. G06F 12/14

(52) U.S. Cl. 713/189

(57) ABSTRACT

Method for securing encryption keys for encrypting software while providing for secure updates of the key for other or updated versions of the software. A First Encryption Key which is used to encrypt an initial software version includes a FIRST SPLIT portion and a TOKEN portion. The FIRST SPLIT portion can be stored in an anti-tamper storage memory of a hardware product and the TOKEN can be stored in external storage medium so that the FIRST SPLIT and the TOKEN are separately provided to separate personnel of the user while the identity of the First Encryption Key is kept secure by remaining in custody of the provider. The user employs the hardware to combine the FIRST SPLIT and TOKEN to generate the First Encryption Key within the hardware to decrypt the encrypted software. To facilitate updates the provider combines the First Encryption Key with a Second Encryption Key to generate an UPDATE SPLIT for updated software which is encrypted with the Second Encryption Key. The UPDATE SPLIT and encrypted updated software are provided to the user who employs the hardware to calculate the Second Encryption Key from the FIRST SPLIT, UPDATE SPLIT and the TOKEN. This allows the identity of the Second Encryption Key to also remain secure in the custody of the provider. The Second Encryption Key which can be sequential or non-sequential with the First Encryption Key, is used within the hardware product to decrypt the encrypted updated software.

### FIELD OF THE INVENTION

This invention relates in general to the field of secure communication and cryptography, and in particular to the management of encryption keys wherein such keys for different versions of software can be securely provided in either sequential or non-sequential order.

### BACKGROUND OF THE INVENTION

Modern electronic products often include licensed software that is updatable to a new or other version in the field such as at a customer's premises. Unfortunately, unauthorized persons often endeavor to copy or use software for their own purposes thereby depriving the software licensor of revenue and/or creating a breach of security. Such unauthorized copying or use is most likely to occur after the software has left the custody of the software provider during distribution of the software or after the software has been installed in the field.

One solution to this problem is for manufacturers of software or other software providers to utilize an encryption key to encrypt such software before it is released for distribution or installed in the equipment of a customer or other user. Such encryption can be applied to all types of software including operating programs, application programs, security programs or secure telephone operating programs, for instance. Users and therefore unauthorized users require the encryption key to be available in their equipment so that they can decrypt and then make use of encrypted software. Such encryption also provides source code privacy because even through the authorized user can run the software such user does not have access to the software source code. Hence, the software is protected from being back engineered. Thus, use of an encryption key to encrypt software before it is released for distribution or before it is loaded into a product such as a computer, telephone, etc., helps to solve the problem of unauthorized copying, back engineering/and or use of such software. Such key based encryption however raises the new problem of how to secure or “manage” the key for such encrypted software because if an unauthorized user obtains the encryption key then the unauthorized user could still copy or otherwise make unauthorized use the software.

It is common for software to be regularly updated such as every six months or each year. Since the equipment used by valid users or licensees of such software necessarily has to have access to the encryption key in some form to utilize such updated encrypted software, it is desirable for such keys and updated software and new or previous versions thereof to be inexpensively and conveniently distributed through public channels such as over the internet or by regular mailing of a floppy disk. During such distribution process such encryption keys can be vulnerable.

One prior art solution for protecting the update encryption key for each new version of software involves the product enabling an encryption key already in the possession of the user to encrypt itself to generate a second key for a second version of the software and then encrypting that key with itself to generate a third key to decrypt a third version of the software and so on. Other prior art methods program the product to run the key through a function to get a second key and then run that second key through another function to get a third key and so on. Hence, the key automatically regenerates itself with each sequential iteration. These solutions provide a degree of protection for subsequent keys because such keys don't have to be distributed, for instance.

The problem with foregoing prior art approaches is that each version of the software must be sequentially loaded into the product. More specifically, such approaches do not lend themselves to allowing the customer or user to either skip software versions by going back to previous software versions in a non-sequential order or forward to later versions in a non-sequential order. More particularly, the foregoing prior art solutions require that the user load version 1 of the software, then version 2, then version 3, etc. in correspondence to the sequential key update. The software user cannot skip from version 3 to 1 or from 1 to 3 for instance. Many customers or users, however, do not obtain every revision of software. For instance, the customer may have version 1 and desire to next license version 4 or vice versa. Alternatively some customers do obtain every version of the software.

Accordingly, what is needed is a method by which different versions of key encrypted software and their keys can be securely provided in either a sequential or in non-sequential order. Moreover, it is advantageous for such software and keys to be securely distributable over the internet and through other public channels. Moreover, it is desired that either sequential or non-sequential keys be independent of previous keys. More particularly, there is a need to provide either sequential or non-sequential versions of software each having its own unique encryption keys without jeopardizing other existing keys. Such keys can either accompany corresponding versions of the software or such keys can activate or deactivate software modules previously resident in a product.

Some security systems enable an authorized user to be identified through the use of a security token or a personal identification number. There is also a need for updated or different versions of encrypted software to be installed or serviced by administrative personnel who do not have access to such tokens.

### BRIEF DESCRIPTION OF THE DRAWINGS

The invention is pointed out with particularity in the appended claims. However a more complete understanding of the present invention may be derived by referring to the detailed description and claims when considered in connection with the figures.

FIG. 1 is a simplified block diagram of a hardware product for illustrating the installation of a preferred embodiment of the present invention;

FIG. 2 illustrates a programming procedure or method for preparing an Initial Software Product in a manner suitable for either sequential or non-sequential updating in accordance with an embodiment of the present invention; and

FIG. 3 illustrates a programming procedure for either sequential or non-sequential updating of a Different Version of the Software Product in accordance with an embodiment of the present invention.

The examples set out herein illustrate a preferred embodiment of the invention in one form thereof, and such examples are not intended to be construed as limiting in any manner.

### DETAILED DESCRIPTION OF THE DRAWINGS

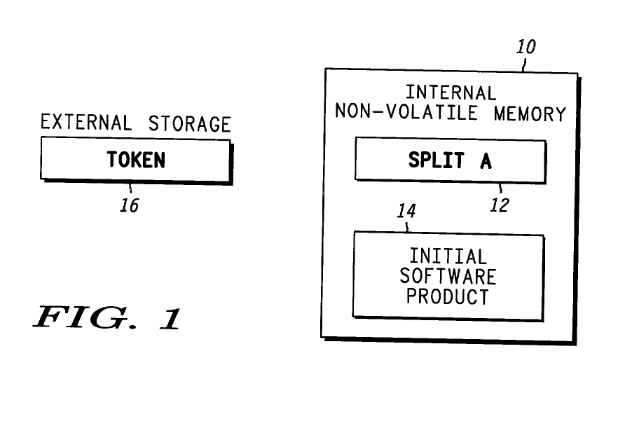

In accordance with the preferred embodiment of the invention for satisfying the above-identified needs, FIG. 1 shows hardware product 10 suitable for using software such as a computer or a secure telephone which includes a microprocessor. Such hardware product 10 has an internal nonvolatile memory 12 and another memory 14 such as a hard disk suitable for storing, encrypting, decrypting and running decrypted software that may be in the form of an operating system or an application program, etc. TOKEN storage medium 16 can be in the form of a smartcard or any other easily transferable medium such as a floppy disk. Alternatively, medium 16 could be a piece of paper having a personal identification number (PIN) or other access control code or information written on it. Storage medium 16 is physically separate from product 10 so that the TOKEN or PIN can be delivered separately to different personnel of the user than product 10.

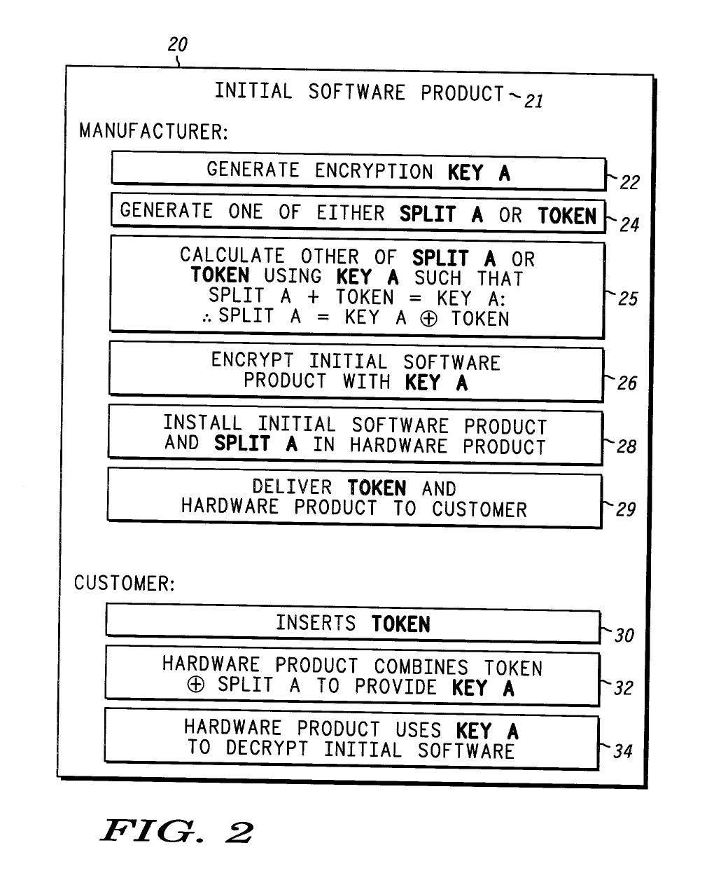

Referring now to FIG. 2, the steps of a method or a procedure in accordance with preferred embodiment of the invention are depicted in block 20 by which a software manufacturer creates or provides an updateable Initial Software Product 21 to be stored in memory 14 and a decryption code called a SPLIT to be stored in memory 12 for delivery or use by a customer. It is desired that the Initial Software Product be capable of either sequential or non-sequential updates in a secure manner. As indicated by step 22 of FIG. 2, an encryption KEY A is generated by a random number generator, for instance. As depicted in step 24 the manufacturer next uses a random number generator, for instance, to provide one of either SPLIT A or the TOKEN. Next the manufacturer, as indicated by step 25, calculates the other of SPLIT A or the TOKEN such that the SPLIT A⊕+TOKEN=KEY A. This calculation can be performed by utilizing modulo-2 addition of KEY A and the already generated one of the SPLIT A or the TOKEN. Modulo-2 addition, which is well known in the art, is also known as an “exclusive or” mathematical or logic operation and is designated by the “⊕” symbol. More specifically, if the TOKEN is provided either by a random number generator or by the customer, for instance, then SPLIT A can be calculated in a known manner by utilizing a computer to perform the “exclusive or” logic operation on KEY A and the TOKEN. Thus SPLIT A=KEY A⊕TOKEN. KEY A, the TOKEN and SPLIT A are sequences of binary numbers comprised of “1's” and “0's”. The manufacturer encrypts the Initial Software Product using KEY A as shown in step 26. This encryption step can, of course, occur any time after generation of KEY A in step 22 but before release of the Initial Software Product to users. The manufacturer keeps a record or copy of KEY A, and optionally can keep a copy of the TOKEN and/or SPLIT A.

As indicated by step 28, the manufacturer installs the encrypted software in memory 14 and SPLIT A in memory 12. Next step 29 indicates that the manufacturer provides or delivers the hardware product 10 having the encrypted Initial Software Product stored in memory 14 and SPLIT A stored in memory 12, along with the TOKEN stored in a separate storage medium 16, to appropriate customer personnel.

Since encryption KEY A is not delivered to the user or customer, KEY A remains secure in the custody of the provider at the manufacturer's facility. The TOKEN may be provided only to customer personnel that are authorized to decrypt and use the software. Hardware product 10 including SPLIT A in internal nonvolatile memory 12 and the encrypted Initial Software Product in memory 14 may be provided separately from the TOKEN to administrative personnel at the customer's facility who service such equipment. Prior art anti-tampering technology can be employed to cause memory 12 to destroy SPLIT A if memory 12 is tampered with. As a result, additional security is provided because user's administrative or custodial personnel have access to neither the TOKEN nor to SPLIT A. This is an important feature for high security applications.

As depicted by step 30 of FIG. 2 the authorized user then inserts the TOKEN. Step 32 depicts that hardware product 10 combines by the “exclusive or” logic operation the TOKEN with SPLIT A to derive KEY A within product 10, as follows:

TOKEN⊕SPLIT A=TOKEN⊕(KEY A⊕TOKEN) KEY A.

Only the product 10 has access to KEY A, the user does have access to KEY A. The authorized user can then operates product 10 to utilize KEY A to decrypt the encrypted Initial Software Product per step 34 and execute or run this software so that it performs its intended purpose.

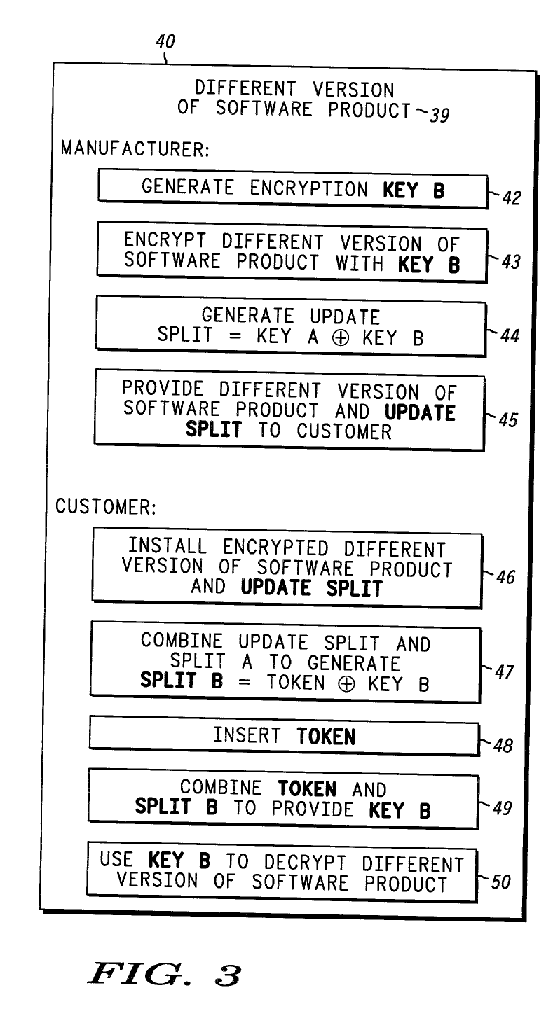

As previously mentioned, software updates frequently occur. There may also have been versions of the software product preceding the Initial Software Product provided to the customer in accordance with FIG. 2. It is assumed for purposes of illustration that there is a need to provide the customer with the Different Version of the Software Product 39 which may be a version which is either subsequent to or previous to the Initial Software Product already provided to the customer. In response to this need, the manufacturer initiates process 40 shown in FIG. 3. As indicated by step 42, the manufacturer first generates new encryption KEY B. KEY B can be generated by a random number generator for instance. The Different Version of the Software Product 39 is then encrypted with KEY B as indicated by step 43 sometime before release for delivery. After KEY B is provided or generated, the manufacturer generates an UPDATE SPLIT by performing the “exclusive or” logic operation, for instance, on KEY A and KEY B as indicated by step 44 of FIG. 3. The manufacturer then provides the encrypted Different Version of the Software Product along with UPDATE SPLIT for installation by the customer as indicated by step 45. There is no information in the UPDATE SPLIT about KEY A or KEY B because the UPDATE SPLIT is merely the “exclusive or” combination of two random numbers. Thus the UPDATE SPLIT does not require protection. Hence, the encrypted Different Version of the Software Product and the UPDATE SPLIT can be provided to the customer over the internet or on a floppy disk sent through the mail or through some other public media, for example. This facilitates efficient, inexpensive open channel distribution of different versions of the software product with their corresponding UPDATE SPLITS without risking a breach of security. Alternately, the UPDATE SPLIT can be employed to activate or deactivate software programs or modules previously provided in memory 14.

As indicated in step 46 the customer then installs the encrypted Different Version of the Initial Software Product and the UPDATE SPLIT in hardware product 10. Hardware product 10 already has SPLIT A and the TOKEN. Step 47 indicates product 10 then combines the UPDATE SPLIT and SPLIT A to generate another SPLIT B which is equal to the combination of the TOKEN and KEY B. The mathematics describing step 47 follow:

SPLIT B=UPDATE SPLIT⊕SPLIT A=(KEY A⊕KEY B)⊕(KEY A⊕TOKEN)=KEY B⊕TOKEN.

If desired the insertion of the TOKEN can again be required per step 48. Hardware product 10 is then operated by the authorized user to combine or “exclusive or” the TOKEN and SPLIT B to provide KEY B as indicated in step 49. The mathematics describing step 49 follows:

SPLIT B⊕TOKEN=(KEY B⊕TOKEN)⊕TOKEN=KEY B

KEY B can then be used to decrypt or unlock the Different Version of the Software Product as indicated in step 50 of FIG. 3. Then the Different Version can then be executed by product 10.

Thus the above processes or methods of blocks 20 and 40 enable encryption of software with an encryption KEY. The encryption KEY is changeable for new or different versions of software. Neither of the encryption KEYS A nor B are either exposed outside of or required to leave the manufacturer's premises during the above processes. Nonsecure distribution channels can be utilized to facilitate secure and economic distribution of the different versions of the software and their corresponding UPDATE SPLITS. It is possible to either sequentially or non-sequentially update any version of the software in the customer's possession with any previous version or any future version by utilizing the above methods.

The foregoing methods take advantage of the fact that the encryption KEY variables are kept in two portions, i.e. the SPLIT and TOKEN. One portion is resident or becomes resident in the hardware device 10 containing the encrypted software or data and has been referred to as the SPLIT. The other portion is held by an authorized person in a second storage device 16 apart from the hardware product 10 and is referred to as the TOKEN. The encryption KEY is the result of combining the SPLIT with the TOKEN. The above described methods allow distribution and replacement of the SPLIT instead of the actual encryption KEYS by administrative personnel without providing them access to the TOKEN which can be kept in the possession of only an authorized user. These results are accomplished by providing updates to the SPLIT in such a way that the existing TOKEN will combine with the updated SPLIT to recover the new encryption key.

Furthermore, a resident software function included in the software product at production but which has not been enabled, can be enabled or disabled in the field or updated so that the function is up to date so that the function can be enabled sometime in the future by providing such resident function as part of the Initial Software Product and later providing an activation SPLIT for such function. Similarly, a software function can be disabled by later providing a deactivation SPLIT for such function. In other words, the SPLIT can be provided at a later time than the software function it enables or disables. Also, as will be apparent to those of ordinary skill in the art, the described “exclusive or” combination steps of methods 20 and 40 can be performed by logic operations other than the described “exclusive or” logic operations.

Although preferred embodiments of the invention have been illustrated, and described in detail, it will be readily apparent to those skilled in the art that various modifications may be made therein without departure from the spirit of the invention or from the scope of the appended claims.

The foregoing description of the specific embodiments so fully reveal the general nature of the invention that others can, by applying current knowledge, readily modify and/or adapt for various applications such specific embodiments without department from the generic concept, and therefore such adaptations and modifications should and are intended to be comprehended and covered within the meaning and range of equivalents of the disclosed embodiment.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for enabling encryption and decryption of an initial version of a software product comprising the steps of:
generating a first encryption key;
encrypting the initial version of the software product with said first encryption key to generate an encrypted initial software product;
generating a first key portion of said first encryption key;
calculating a second key portion by utilizing said first key portion and said first encryption key to generate a said second key portion such that the combination of said first key portion and second key portion form said first encryption key;
providing said first key portion and said second key portion and said encrypted initial software product for use in a hardware product;
combining said first key portion and said second key portion to provide said first encryption key in said hardware product; and
utilizing said first encryption key to decrypt said encrypted initial software product in said hardware product.

2. The method of claim 1 wherein said step of generating a first encryption key utilizes a random number generator to generate said first encryption key.

3. The method of claim 1 wherein said step of calculating a second key portion utilizes an “exclusive or” logic operation to combine said first key portion and said first encryption key to calculate said second key portion.

4. The method of claim 1 wherein said step of combining said first key portion and said second key portion utilizes an “exclusive or” logic operation to combine said first key portion and said second key portion to provide said first encryption key.

5. The method of claim 1 further enabling an update of said first encryption key to provide a second encryption key to secure a different version of the initial software product, further comprising the steps of:
generating the second encryption key;
encrypting the different version of the initial software product with the second encryption key to provide an encrypted different version of the software product;
combining the first encryption key and the second encryption key to provide a third key portion;
installing said third key portion and the encrypted different version of the software product in said hardware product;
combining said third key portion and said second key portion to generate a fourth key portion in said hardware product;
combining the first key portion and the fourth key portion to provide said second encryption key in said hardware product; and
using the second encryption key to decrypt the encrypted different version of the software product.

6. The method of claim 5 wherein said step of providing said second encryption key utilizes a random number generator to generate said second encryption key.

7. The method of claim 5 wherein said step of combining the first encryption key and the second encryption key utilizes an “exclusive or” logic operation to combine said first encryption key and said second encryption key to generate said third key portion.

8. The method of claim 5 wherein said step of providing said second encryption key utilizes an “exclusive or” logic operation to combine said first key portion and said fourth key portion to provide said second encryption key.

9. The method of claim 5 wherein said initial version of software product and said different version of said initial version of said software product are non-sequential versions.

10. The method of claim 5 wherein said second encryption key is non-sequential with said first encryption key.

11. A method for providing for the security of encryption keys for encryption and decryption of an initial version of a software product provided by a provider to a user of a hardware product, said method comprising:
providing a first encryption key;
encrypting the initial version of the software product with said first encryption key to generate an encrypted initial software product;
providing a first key portion;
utilizing said first key portion and said first encryption key to calculate a second key portion such that the combination of said first and second key portions form said first encryption key;
storing said first key portion in storage means external to the hardware;
storing said second key portion separately from said first key portion in a tamper proof memory means in the hardware product;
storing said encrypted software product in a further memory means in the hardware product;
combining said first key portion and said second key portion in the hardware product to provide said first encryption key; and
decrypting said encrypted initial software product with said first encryption key.

12. The method of claim 11 wherein said step of providing a first encryption key utilizes a random number generator to generate said first encryption key.

13. The method of claim 11 wherein said step of utilizing said first key portion and said first encryption key to calculate said second key portion utilizes an “exclusive or” logic operation.

14. The method of claim 11 wherein said step of combining said first key portion and said second key portion utilizes an “exclusive or” logic operation performed by said hardware product.

15. The method of claim 11 further enabling security of an update of said first encryption key and providing a second encryption key for encrypting a different version of the initial software product, further comprising:
generating the second encryption key;
encrypting the different version of the initial software product with said second encryption key to provide an encrypted different version of the initial software product;
combining said first encryption key and said second encryption key to provide a third key portion;
installing said third key portion in said tamper proof memory means;
installing said encrypted different version of the initial software product in said further memory means in the hardware product;
combining said third key portion and said second key portion to generate a fourth key portion in the hardware product;
combining said first key portion and said fourth key portion to provide said second encryption key in the hardware product; and
using said second encryption key in the hardware product to decrypt the encrypted different version of the initial software product.

16. The method of claim 15 wherein said step of generating a second encryption key utilizes a random number generator.

17. The method of claim 15 wherein said step of combining said first encryption key and said second encryption key to generate a third key portion utilizes an “exclusive or” logic operation.

18. The method of claim 15 wherein said step of combining said first key portion and the fourth key portion to provide said second encryption key utilizes an “exclusive or” logic operation.

19. The method of claim 15 wherein said initial version of a software product is non-sequential with said different version of the initial software product.

20. The method of claim 15 wherein said second encryption key is non-sequential with said first encryption key.
